(19) United States
(12) Patent Application Publication
(10) Pub. No.: US 2002/0166988 A1
(43) Pub. Date: Nov. 14, 2002

(54) Drain plug for rail cars

(75) Inventors: Alex Degutis, East Chicago, IL (US); Stan Brzezniak, Chicago, IL (US)

Correspondence Address: JENNER & BLOCK, LLC, ONE IBM PLAZA, CHICAGO, IL, 60611, US

(73) Assignee: Salco Products, Inc.

(21) Appl. No.: 09/858,133

(22) Filed: May 14, 2001

(51) Int. Cl. F16K 1/00

(52) U.S. Cl. 251/144

(57) ABSTRACT

A drain plug assembly for insertion into a drain outlet through the floor of a rotary dump container. The drain plug assembly comprises a plug member, a washer and a securing mechanism. The plug member has a shank and a plug head. The shank is insertable into the drain outlet and includes an upper shank portion and a lower shank portion. The diameter of the lower shank portion is less than the diameter of the upper shank portion so as to define a shoulder along the shank. The washer is slidably fit on the lower shank portion. The securing mechanism secures the washer onto the lower shank portion so as to allow the washer to slide a predetermined distance on the lower shank portion and impact on the shoulder.

### BACKGROUND OF THE INVENTION

This invention relates to a drain plug assembly used in a rotary dump type container to limit the flow of material other than water into the drain outlet. The drain plug assembly further provides structure for dislodging built-up ice from the drain plug assembly and the drain outlet when the container is rotated to dump the container cargo.

Railroad cars regularly carry various bulk materials, such as coal, across the country. A rotary dump hopper car with four sides and a floor forming an open container or hopper is especially suited for this purpose. At the destination, the hopper cars are mechanically rotated so as to dump the cargo, and then uprighted so that they can be moved out of the dumping device. Since most hopper cars are not covered and are open to the weather, water from rain and snow often accumulates in the bottom of the hopper. To drain the water, drainage holes are provided in the floor of the hopper. The drainage holes are designed to be large enough to drain water but small enough to prevent cargo such as chunks of coal from falling out of the hopper. However, the drainage holes do allow small materials such as coal particles to leak from the hopper cars along with the draining water. To minimize the unintended loss of these small particles, cone shaped drainage covers are fixably attached the floor of the hopper to cover the drainage holes. A plurality of equally spaced smaller holes or restricted passageways are defined near the base of each drainage cover. The smaller holes defined in the covers allow the water to drain from the hopper without the loss of small particles of the cargo.

However, exposure to cold weather often causes ice to form on the drainage covers, preventing proper water drainage through the holes. Therefore it is periodically necessary to manually dislodge and break the ice free from the covers, even when the rail cars are rotated and dumped. A clogged drainage cover can cause additional water to accumulate in the hopper after unloading or during the return trip, potentially reducing the quantity and quality of the next cargo payload.

Accordingly, it is desirable to provide a drain plug assembly that is capable of dislodging built-up ice from the drain plug assembly and drain outlet during the unloading operation without worker assistance.

### SUMMARY OF THE INVENTION

The present invention is directed to a drain plug assembly for insertion into a drain outlet through the floor of a rotary dump container. The drain plug assembly comprises a plug member, a washer and a securing mechanism. The plug member has a shank and a plug head. The shank is insertable into the drain outlet and includes an upper shank portion and a lower shank portion. The diameter of the lower shank portion is less than the diameter of the upper shank portion so as to define a shoulder along the shank. The washer is slidably fit on the lower shank portion. The securing mechanism secures the washer onto the lower shank portion so as to allow the washer to slide a predetermined distance on the lower shank portion and impact on the shoulder.

### BRIEF DESCRIPTION OF THE DRAWINGS

FIG. 1A is a side view of the drain plug assembly of the present invention in the normal draining position in a drain outlet through a railcar hopper floor.

FIG. 1B is a side view of the drain plug assembly of the present invention when the hopper is inverted and the washer first impacts against the shoulder of the shank.

FIG. 1C is a side view of the drain plug assembly of the present invention when the rail car is inverted and the washer impacts against the underside of the hopper floor.

FIG. 2A is a cross sectional view of the plug member of the present invention.

FIG. 2B is a bottom view of the plug member of the present invention.

FIG. 3A is a cross sectional view of the washer of the present invention.

FIG. 3B is a top view of the washer of the present invention.

FIG. 4A is a side view of the drain plug assembly of the present invention.

FIG. 4B is a bottom view of the drain plug assembly and securing mechanism of the present invention.

### DETAILED DESCRIPTION OF THE INVENTION

Many of the open hopper railcars used to transport bulk materials such as coal have fixed sides and substantially closed bottoms. At least one drain outlet is provided in the floor of each hopper car compartment to allow collected fluids such as water to drain. The drain outlets minimize the accumulation of water in the hopper car before and after the hopper is dumped. The drain outlets may be approximately 1.0 to 2.0 inches in diameter, which is small enough to prevent cargo such as chunks of coal from dropping from the hopper car while allowing water to drain. However some of the cargo such as smaller coal particles often leak out with the draining water.

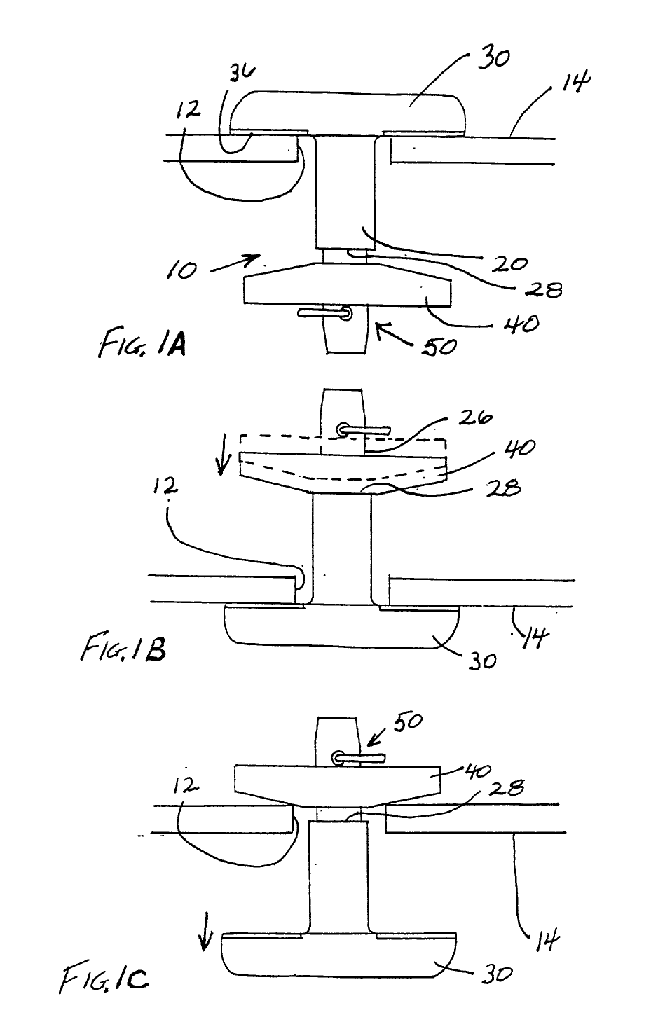

As illustrated in FIG. 1A, a drain plug assembly 10 of the present invention includes a plug member 20, a washer 40 and a securing mechanism 50. The drain plug assembly is shown positioned in a drain outlet 12, which is often simply a hole, for example, through the floor 14 of hopper. The floor of a hopper car is formed of a relatively thin sheet of metal. The thickness of the metal for forming the floor is usually ⅜ inch or thinner. While the floor is shown in a horizontal plane for purposes of illustration, it will be realized that the floor may also be angled somewhat.

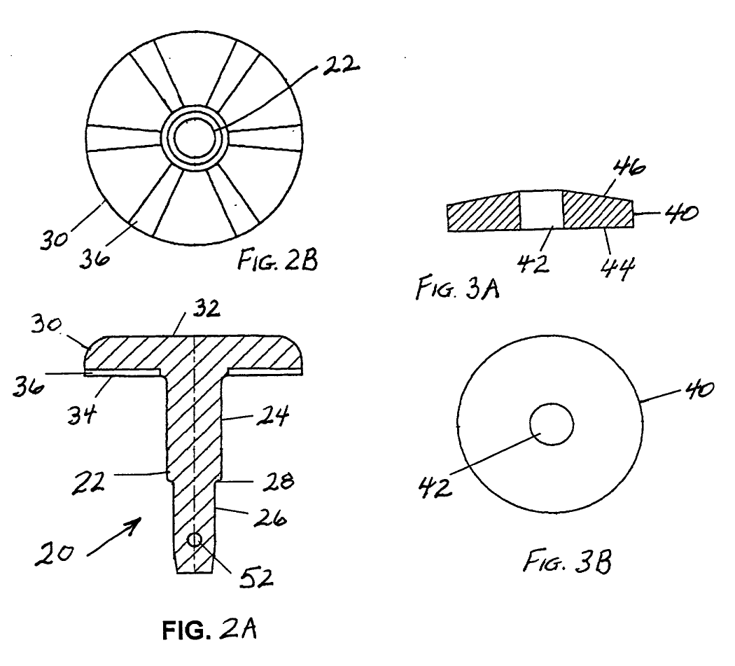

Referring now to FIG. 2A, the plug member 20 includes a dual diameter shank 22 and a plug head 30. The plug member may be made of a suitable metal or preferably made of a cast urethane with a Shore A durometer of about 95. The shank 22 is preferably cylindrical in shape and includes an upper shank portion 24 and a lower shank portion 26. The upper shank 24 has dimensions permitting the insertion of the plug member 20 into the drain outlet 12. The diameter of the upper shank 24 is deliberately less than the diameter of the drain outlet 12 so that there is sufficient clearance between the upper shank 24 and the drain outlet walls to allow fluid to drain at a suitable rate, as will be explained. The length of the upper shank 24 is also greater than the axial thickness of the floor 14 so that the upper shank portion 24 extends completely through the drain outlet and beyond the underside of the floor 14.

The lower shank 26 has a diameter that is smaller than the diameter of the upper shank 24. The lower shank 24 extends axially from the upper shank, thus creating a shoulder 28 where the upper shank 24 meets the lower shank 26. The shoulder 28 is positioned on the shank 22 so as to extend beyond the underside of the floor 14 of the hopper when the plug member 20 is inserted through the drain outlet.

The plug head 30 is preferably a circular disc with a generally flat top surface 32 and a flat bottom or underside surface 34. The top surface 32 of the plug head 30 may have other cross-sectional shapes, such as conical or a dome shaped. The diameter of the plug head 30 is larger than the drain outlet 12 to ensure that only the shank 22 fits through the drain outlet. The plug head 30 is connected to the shank 22 so that the shank 22 and the bottom surface 34 of the plug head 12 are perpendicular to one another.

Multiple drain passages 36 are formed in the underside surface 34 of the plug head 30, as shown in FIG. 2B. The drain passages 36 begin on the outer edge of the plug head and continue radially inward almost to the shank 22. The drain passages create a flow path through the plug head 30 to the drain outlet 12 when the plug member is positioned in the drain outlet, as shown in FIG. 1A.

The drain passages are preferably rectangular in cross-section and flair wider radially away from the shank. However, the quantity, shape and dimensions of the passages 36 can be designed for specific throughput of fluids through the passages. For example, in the embodiment shown in FIG. 2B, six drain passages 36 are spaced evenly along the circumference of the plug head 30. The quantity, spacing and dimensions of the drain passages 36 is designed to be sufficient to drain the accumulated fluid in the open hopper compartment.

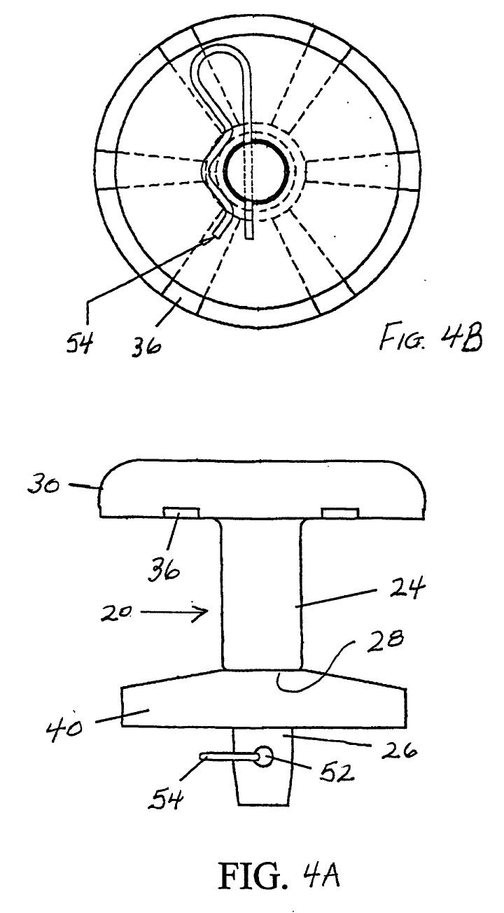

Referring now to FIGS. 3A and B, the washer 40 is preferably disk-shaped with a center aperture 42. The bottom surface 44 of the washer may be flat and the top surface 46 may be gradually sloped, so that the axial thickness of the washer 40 is smaller at the outer edge than at the center. The diameter of the washer 40 is larger than the diameter of the drain outlet 12 to ensure that the washer 40 cannot fit through the drain outlet.

The diameter of the aperture 42 at the center of the washer is larger than the diameter of the lower shank 26 and smaller than the diameter of the upper shank 24. Thus, the washer 40 can slide on the lower shank 26 and abut against the shoulder 28 when the washer 40 is fit over the lower shank 26, as shown in FIG. 4A. The washer 40 is preferably constructed from a material having a high specific gravity, such as rubber with a specific gravity of about 4.0. While other materials may be used, it is preferable that the washer 40 be thick enough to provide a substantial weight in order to assist in breaking the plug member 20 free from any ice build-up when the rail car is inverted as described below.

A securing mechanism 50 is shown in FIGS. 4A and 4B. The securing mechanism 50 is positioned on the lower shank portion 26 at a predetermined distance away from the shoulder 28. The predetermined distance must be greater than the axial thickness of the washer 40. In the disclosed embodiment of FIG. 4A, for example, the securing mechanism includes a transverse hole 52 located at a predetermined distance from the shoulder 28 along the lower shank 26. The transverse hole extends laterally through the lower shank 26. A retaining pin 54 such as a cotter pin can be inserted through the transverse hole 52 to secure the washer 40 onto the lower shank 26. Alternative securing mechanisms, such as a snap ring may also be used.

The length of the upper shank portion 24 should be greater than the thickness of the floor 14 so that shoulder 28 extends beyond the underside of the floor. The distance on the lower shank 26 from the shoulder 28 to the securing mechanism 50 should also be greater than the axial thickness of the washer 40, as measured at the washer center. The extra length allows the washer 40 to slide on the lower shank portion 26 when the rail car is inverted.

In operation, the dual diameter shank 22 of the plug member 20 is inserted into the drain outlet 12 from the inside of the rail car. Once inserted, the plug head 30 rests against the car floor, covering the drain outlet 12. In this inserted position, the shoulder 28 at the end of the upper shank 24 and the entire lower shank 26 extends through the floor 14 of the hopper and beyond the underside of the floor. The washer 40 is then positioned on the lower shank 26 from beneath the railcar. The securing mechanism 50, such as retaining pin 54 is then inserted though the transverse hole 52, preventing the washer 40 from falling off the shank 22. During normal transport, the drain plug assembly 10 remains over the drain outlet 12. Any water that accumulates in the car bed during transport moves through the drain passages 36 located in the plug head 30 and out through the drain outlet 12.

During cold weather, some of the water in the bed of the hopper may turn to ice, thus blocking the drain passages 36 and preventing water from properly draining. This drain blockage may require human intervention to unblock the passages. For example, a worker with a tool can hit each blocked plug shank 22 from the underside of the railcar, dislodging the built-up ice. But this extra labor adds time and expense to the unloading process.

Upon reaching its destination, the hopper car is inverted to dump its cargo. Because the thickness of the washer 40 is smaller than the distance from the securing mechanism 50 to the shoulder 28 in the present invention, the washer 40 slides axially on the lower shank 26. Thus, as shown in FIG. 1A, when the hopper car with the inserted drain plug assembly 10 according to the present invention is inverted, the heavy washer 40 will accelerate from its resting place against the retaining pin 54, for example, and impact against the inverted and exposed shoulder 28 on the two diameter shank 22, as shown by the arrow in FIG. 1B. This impact produces an axial force on the plug member 20 to break free from any ice that has formed around the plug head 30 or shank 22. The drain plug assembly 10 then continues to move axially downward in the drain outlet 12 until the washer 40 impacts against the inverted underside of the floor 14, as shown in FIG. 1C for example. The plug member 20 separates from the washer 40 and continues to move axially, as shown by the arrow in FIG. 1C, until restrained by the securing mechanism 50. This secondary impact and independent movement by the plug member 20 further clears ice from the drain plug assembly 10 and drain outlet 12.

The rail car is then re-inverted to its normal position and the plug head 30 once again comes to rest against the drain outlet 12. Built-up ice has been cleared from the drain plug assembly 10 and drain outlet 12. Accumulated and unwanted water can once again properly drain from the hopper.

Furthermore, the washer 40, due to its heavy weight, helps to prevent accumulation of ice or dislodge accumulated ice while the car is in motion. As the car is in motion, vibration of the hopper car is transmitted through the plug assembly 10 causing the washer 40 to vibrate or move. This movement of the washer helps to prevent accumulation of ice in the drain plug assembly 10. In addition, should any ice have been accumulated in the drain plug assembly 10 when the car was not moving, the movement of the washer when the car is in motion will help to dislodge the ice accumulated in the drain plug assembly 10.

The drain plug assembly 10 may be readily removed from the hopper car drain outlet 12 by simply removing the securing mechanism 50, such as pin 54, and the washer 40 from the lower shank portion 26. The plug member 20 is then lifted out of the drain outlet 12. The drain plug assembly 10 can then be replaced with a new assembly or reused later in a different rail car.

Whereas a preferred form of the invention has been shown and described, it will be appreciated that modifications may be made using other methods and materials without departing from the scope of the invention defined by the following claims.

What is claimed is:

1. A drain plug assembly for insertion into a drain outlet through the floor of a rotary dump container, the drain outlet having an outlet diameter and the container floor having a floor thickness, the drain plug assembly comprising:
a plug member having a shank and a plug head, the shank being insertable into the drain outlet and including an upper shank portion having an upper shank diameter and a lower shank portion having a lower shank diameter that is less than the upper shank diameter so as to define a shoulder along the shank;
a washer slidably fit on the lower shank portion; and
a securing mechanism securing the washer onto said lower shank portion so as to allow the washer to slide a predetermined distance on said lower shank portion and impact on said shoulder.

2. The drain plug assembly of claim 1 wherein said washer has a diameter that is larger than the lower shank diameter and smaller than the upper shank diameter.

3. The drain plug assembly of claim 1 wherein said washer has a washer thickness and said securing mechanism is located on said lower shank portion at a position away from the shoulder that is greater than the washer thickness.

4. The drain plug assembly of claim 1 wherein said securing mechanism comprises a transverse hole through the lower shank portion and a retaining pin insertable in said transverse hole.

5. The drain plug assembly of claim 1 wherein the plug head has drain passageways through the plug head so that when the shank is inserted in the drain outlet, the plug head covers the drain outlet and the drain passageways communicate with the drain outlet.

6. The drain plug assembly of claim 5 wherein the plug head further comprises an underside surface facing the container floor and the drain passages are on the underside surface.

7. The drain plug assembly of claim 6 wherein said drain passages are radial extending channels in the underside surface of the plug head.

8. The drain plug assembly of claim 7 wherein said drain passages are rectangular in cross-section and flair radially outward from the drain outlet.

9. The drain plug assembly of claim 1 wherein the washer has a thickness and the thickness of said washer is less than the distance along the lower shank from the shoulder to the securing means.

10. The drain plug assembly of claim 1 wherein the washer is made from a material having a specific gravity of at least 4.0.

11. The drain plug assembly of claim 1 wherein the upper shank diameter that is less than the drain outlet diameter.

12. The drain plug assembly of claim 1 wherein the upper shank length is greater than the floor thickness.

13. A drain plug assembly for insertion into a drain outlet through the floor of a rotary dump container, the drain plug assembly comprising:
a plug member having a shank and a plug head, the shank being insertable into the drain outlet and including an upper shank portion, a lower shank portion, a first abutment surface defined near one end of the lower shank portion and a second abutment surface defined near other end of the lower shank portion; and
a washer slidably mounted on the lower shank portion between the first abutment surface and the second abutment surface.

14. The drain plug assembly of claim 13 wherein thickness of the washer is less than length of the lower shank portion.

15. The drain plug assembly of claim 13 wherein diameter of the upper shank portion is greater than diameter of the lower shank portion.

16. The drain plug assembly of claim 13 wherein a shoulder along the shank defines the first abutment surface.

17. The drain plug assembly of claim 13 wherein a retaining pin defines the second abutment surface.

18. A drain plug assembly for insertion into a drain outlet through the floor of a rotary dump container, the drain plug assembly comprising a plug member having a shank and a plug head, the shank insertable into the drain outlet and having a portion slidable relative to the floor, the slidable portion having a length greater than thickness of the floor.

19. The drain plug assembly of claim 18 further comprising a washer slidably mounted on a second portion of the shank.
